(19) United States
(12) Patent Application Publication
(10) Pub. No.: US 2011/0153358 A1
(43) Pub. Date: Jun. 23, 2011

(54) PROTOCOL COMPLEXITY ANALYZER

(75) Inventors: Rafael Alejandro Campo, Wyncote, PA (US); Edward Stephen Seguine, Furlong, PA (US)

(73) Assignee: MEDIDATA SOLUTIONS, INC., New York, NY (US)

(21) Appl. No.: 13/062,259

(22) PCT Filed: Sep. 1, 2009
(86) PCT No.: PCT/US09/55604

§ 371 Date: Mar. 4, 2011

(30) Foreign Application Priority Data
Sep. 11, 2008 (US) 61096130

(51) Int. Cl. G06Q 10/00

(52) U.S. Cl. 705/2

(57) ABSTRACT

The present invention includes a system and methods for planning a medical study. The system for planning a medical study includes a display device and a data store comprising a plurality of medical procedures for at least one of designing and executing a medical study. The system further includes a service delivery device operatively coupled to the display device and the data store. The service delivery device includes a processor and a memory for storing instructions. In response to receiving a request to plan a medical study, the memory causes the processor to (1) select a set of procedures from the plurality of medical procedures; (2) assign a work effort unit for each procedure included in the set of procedures, with the work effort unit based on at least one of procedure type, procedure cost, procedure time, and procedure phase; (3) calculate a complexity level for the set of procedures based on the work effort units; and (4) evaluate whether the complexity level is appropriate for the medical procedure by comparing the calculated complexity level to a threshold level, where the threshold value represents a desirable complexity level for the study.

### FIELD OF THE INVENTION

The disclosure generally relates to medical studies, and more particularly to assessing the complexity of designed medical studies and making subsequent discussions and/or modification to the design of the study based on the complexity assessments.

### BACKGROUND OF THE INVENTION

Clinical trial protocols are designed to produce scientifically sound new knowledge about the safety, efficacy, or specific therapeutic characteristics of a new drug or treatment combination. Clinical trial protocols developed using modern medical study design principles have well-understood statistical hypothesis testing and internal validity characteristics. Thus, modern clinical studies are designed to deliver the most supportable scientific knowledge with the smallest number of study subjects. Despite these more efficient study designs, the complexity and associated costs of executing new protocols continue to increase.

The rising complexity of current protocol designs has resulted in a dramatic increase in the operational management overhead required to initiate, execute, and complete a clinical trial successfully within a budget and a time frame. With the increasing number of patients, investigators, locations and countries involved in a given trial, it is not surprising that many clinical trials have significant operational issues that cause substantial cost/time over-runs or outright trial failures.

A distinction between scientific versus operational issues in clinical trials planning and execution is important. A scientific issue arises due to the limited state of current knowledge about the trial agent(s) pharmacologic and therapeutic properties in the experimental clinical situation. This lack of scientific knowledge is precisely the reason a well-designed clinical trial is required. Scientific issues are ethically justified and do not indicate any problem with the clinical trial protocol. Operational issues arise because of unforeseen difficulties in executing the clinical trial within the strict parameters or assumptions embedded implicitly or explicitly within the protocol design. In this case, the protocol designers may not have been able to predict the difficulties the field organization or clinical investigators have in operationalizing specific study design components. Furthermore, the design protocols vary by therapeutic area, adding to the difficulty in predicting operational issues in clinical trials.

Operational deficiencies can be costly to an organization, especially if they require an amendment to the protocol during execution of the trail. Even simple amendments have substantial costs, including the internal overhead of detecting the need for an amendment, the costs related to creating the amendment, the internal approval costs for releasing the amendment, the costs for disseminating the amendment, and the follow-up effort to ensure that the amendment has been incorporated into the clinical trial process at a potentially large number of trial sites. The cost of an amendment also includes the opportunity costs due to delay in the completion of the medical study or data analysis impact due to inconsistent operational behavior at the trial sites.

One operational element of designing protocols is calculating the protocol complexity. Traditionally, the protocol complexity is determined by multiplying the clinical procedures by the frequency and summing all procedures, which is referred to as a crude estimate of the complexity. For example, if a protocol has ten (10) clinical trial procedures and each procedure must be completed five times during the clinical trial, the complexity value for the protocol would be fifty (50). This methodology has been used to measure complexity. The major drawback of this methodology is that each clinical procedure has the same weight. For example, using the current methodology a blood draw has the same impact on the overall complexity of a clinical trial design as an MRI.

In recent years, there has been a growth in complexity of protocol designs and rising administrative demands to execute more procedures. For example, during the past ten years, drug development programs are targeting chronic illnesses, which are more difficult to treat and require longer and more elaborate methods to measure safety and efficacy. Additionally, regulatory agency requirements may also be attributable to the growing complexity of protocol designs because protocols are being designed to anticipate what regulatory agencies will require. Studies have shown that the more complex a clinical trial protocol is, the less efficient and effective a study may be. Therefore, the studies indicate that improvements to the planning and designing of clinical trial protocols may enhance the efficiency and effectiveness of clinical trails, especially in research-based pharmaceutical and biopharmaceutical industries.

Thus, it would be advantageous to provide a method of improving the planning of a clinical trial by reducing the need for amendments, such as for designs that do not properly estimate the costs and time involved for each procedure, by providing a complexity computation that can be used in the designing and planning process. Additionally, it would be beneficial to design a protocol that allows a physician to assess the complexity of each procedure determined by the cost, time, effort, and expertise required for each procedure.

### SUMMARY OF THE INVENTION

The present invention includes a system and methods for planning a medical study.

The system for planning a medical study includes a display device and a data store comprising a plurality of medical procedures for at least one of designing and executing a medical study. The system further includes a service delivery device operatively coupled to the display device and the data store. The service delivery device includes a processor and a memory for storing instructions. In response to receiving a request to plan a medical study, the memory causes the processor to (1) select a set of procedures from the plurality of medical procedures; (2) assign a work effort unit for each procedure included in the set of procedures, with the work effort unit based on at least one of procedure type, procedure cost, procedure time, and procedure phase; (3) calculate a complexity level for the set of procedures based on the work effort units; and (4) evaluate whether the complexity level is appropriate for the medical procedure by comparing the calculated complexity level to a threshold level, where the threshold value represents a desirable complexity level for the study.

A first computer-implemented method of planning and executing a medical study includes selecting a set of procedures from a plurality of medical procedures accessible from an electronic data store. Then, a work effort unit is assigned to each procedure included in the set of medical procedures. The work effort unit is based on at least one of procedure type, procedure cost, procedure time, and procedure phase. After that, a complexity level is calculated for the set of procedures based on the work effort units. Finally, the appropriateness of the complexity level is evaluated by comparing the calculated complexity level to a threshold level, where the threshold value represents a desirable complexity level for the study.

A second computer-implemented method of determining a complexity level for a medical study includes determining a work effort unit for each procedure included in a set of medical procedures. The work effort unit is based on at least one of procedure type, procedure cost, procedure time, and procedure phase. Then, all unique procedures included in the set of medical procedures are identified. After that, the work effort unit is multiplied by a number of occurrences of each of the unique procedures in the set of medical procedures. Finally, the multiplied work effort units are summed.

Other objects and features of the present invention will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

FIG. 1 is a block diagram of a system for designing a medical study according to the present invention;

FIG. 2 illustrates an exemplary method of calculating a work effort unit.

FIGS. 3-13 provide computer screen shots of the present invention.

FIGS. 14-16 provide examples of output report from the present invention

Like reference symbols in the various drawings indicate like elements.

### DETAILED DESCRIPTION OF THE PREFERRED EMBODIMENTS

Medical practices produce a variety of services that can be counted in “relative value units” (RVUs). RVUs are non-monetary, numeric values that Medicare has developed to determine reimbursement rates. RVUs represent the relative amount of physician time, resources, and expertise needed to provide various services to patients. The total RVU reimbursement rates are composed of three component RVU values, which are added together and then multiplied by a conversion factor. The result is a cost Medicare feels is a fair reimbursement for that procedure.

For purposes of planning a clinical trial, the present invention uses the RVU value to calculate the complexity of the procedures. In particular, an RVU value or a RVU-like value will be assigned to every clinical procedure in a clinical trial.

To implement the new value, the present invention will include a table or other data structure capable of listing the unique clinical procedures and other direct costs (ODCs) which have been called for in a clinical trial protocol. Since this invention relates to planning clinical trials for medical studies, clinical procedure values are the most important for the complexity analysis. Most clinical procedures included in the clinical trial have a Current Procedure Terminology (CPT) code and an associated Relative Value Unit (RVU). The procedures without a CPT code are procedures not recognized by the American Medical Association (AMA) and are almost exclusively procedures used in clinical trials, such as questionnaires, scales, and study volunteer assessments. Other clinical procedures which may not have a CPT code are procedures not reimbursed by Medicare, since Medicare deems that the procedures do not include significant work by the physician or the site, such as laboratory procedures.

For clinical procedures without the CPT codes, the unique codes may be assigned according to an internal coding methodology. The internal coding methodology of the present invention is a workload scale based on the estimated costs in administrating the procedure, where the workload factors include the amount of time involved in preparing the clinical procedure, conducting the clinical procedure, and completing the clinical procedure. Examples of clinical trial procedural groupings used for determining the complexity of procedures in a clinical trial may include, but are not limited to the following: (1) lab test, such as laboratory test, panels, and cultures for vitamin levels, infectious and bacterial agents, and toxins; (2) blood work, such as laboratory tests and assays examining hematology and coagulation, such as blood counts, bone marrow compositions, and prothombin/thromboplastin times; (3) questionnaires and subjective assessments, such as self-administered or physician administered questionnaires, rating scales, and assessments for psychological and medical conditions; (4) office consultations and examinations, such as full evaluation and management procedures for both medical and psychological conditions and both new patient and follow-up examination; (5) x-rays and imaging, such as preventative and diagnostic procedures including ultrasounds, cat scans, x-rays, and MRIs; and (6) heart activity assessments, such as ECGs, EKGs, stress tests, and electro-cardiographic monitoring for both diagnostic and preventative purposes.

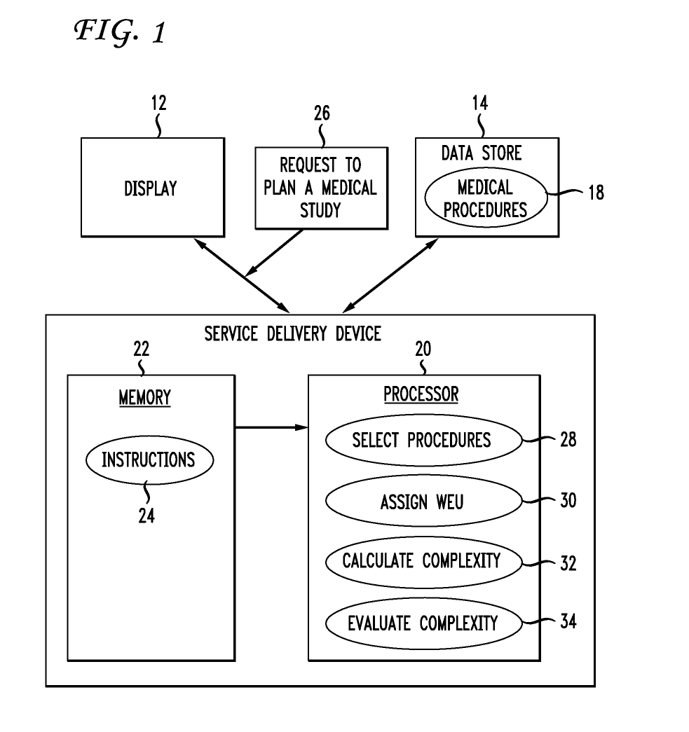

FIG. 1 provides a block diagram of a system for designing a medical study of the present invention. The system includes three main components: a display 12, a data store 14, and a service delivery device 16. The display 12 may be a graphical user interface or any other display device known to one skilled in the art. The data store 14 includes a plurality of medical procedures 18 for at least one of designing and executing a medical study. For example, the data store 14 may include a procmstr, which is a table containing all unique procedures in the database, and a procedur, which is a table containing every procedure for each protocol in the database.

The service delivery device 16 (or computing device) is operatively connected to the display 12 and the data store 14 and further includes a processor 20 and a memory 22 for storing instructions 24 that, in response to receiving a request to plan a medical study 26, cause the processor 20 to select a set of procedures 28 from the plurality of medical procedures 18 and estimate a cost in administrating at least one procedure included in the set of procedures 28. The instructions stored in the memory 22 may be one or more instructions selected from the list consisting of causing the processor 20 to: (1) identify unique procedures included in the set of procedures; (2) determine a Procedure Work Effort (PWE) by multiplying a work effort unit (WEU) 30 by the number of occurrences of each unique procedure by the WEU and determine a Site Work Effort (SWE) by summing the PWE; (3) estimate a cost in administrating at least one procedure included in the set of procedures; and (4) modify the set of procedures in response to a comparison of the calculated complexity level to a threshold value by adding, removing, or modifying a procedure included in the set of procedures 28. Then, the service delivery device 16 uses the processor to assign the WEU 30 for each procedure 18 included in the set of procedures 28, calculate a complexity level 32 for each set of procedures 28 based on the assigned WEU 30, and evaluate 34 the appropriateness of the complexity level for the set of procedures 28 by comparing the calculated complexity level 32 to a threshold level, where the threshold value represents a desired complexity level for the study.

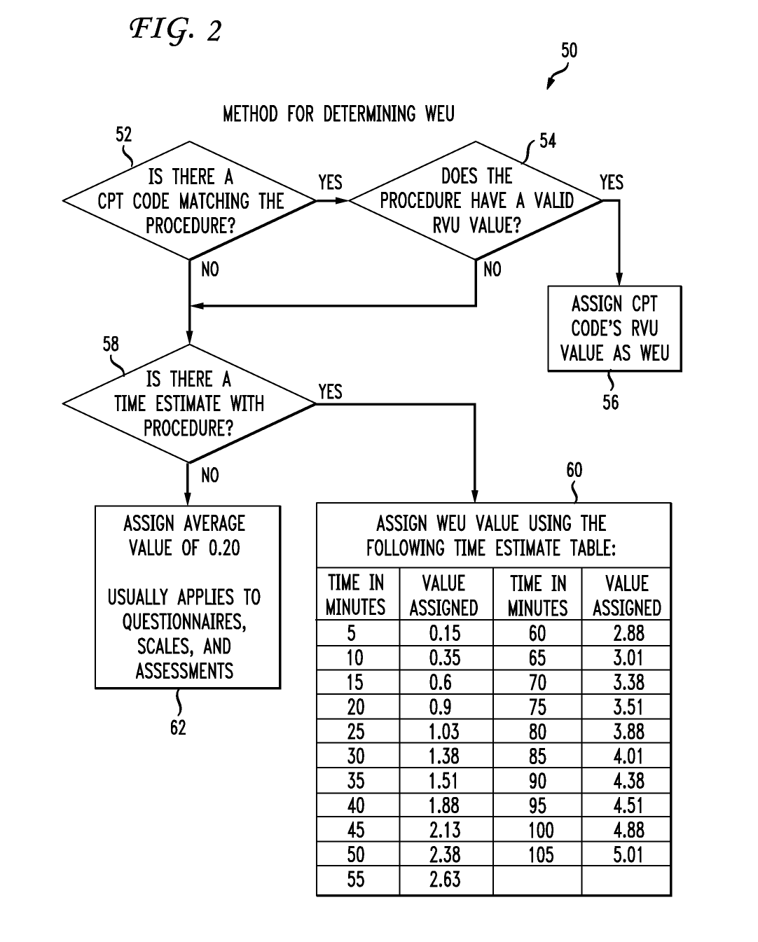

The WEU 30 is based on at least one of the following: procedure type, procedure cost, procedure time, and procedure phase. The WEU 30 used for the present invention includes RVU values and non-RVU values for each clinical procedure. As shown in FIG. 2, the WEU 30 may be calculated using the following exemplary method of calculating work effort unit 50. First, the processor assigns the WEU 30 by determining if there is a CPT code matching the clinical procedure 52. If a CPT code matches the clinical procedure, the method checks for a valid RVU value 54. If a valid RVU value is present, the RVU value is assigned 56 as the WEU value 30, but when there is no RVU value and/or no matching CPT code, the method processor determines if there is a time estimate of the procedure 58. If there is a time estimate, the WEU value 30 is assigned using a time estimate table 60. When no time estimate exists, an average value of 0.20 is assigned 62 as the WEU value 30.

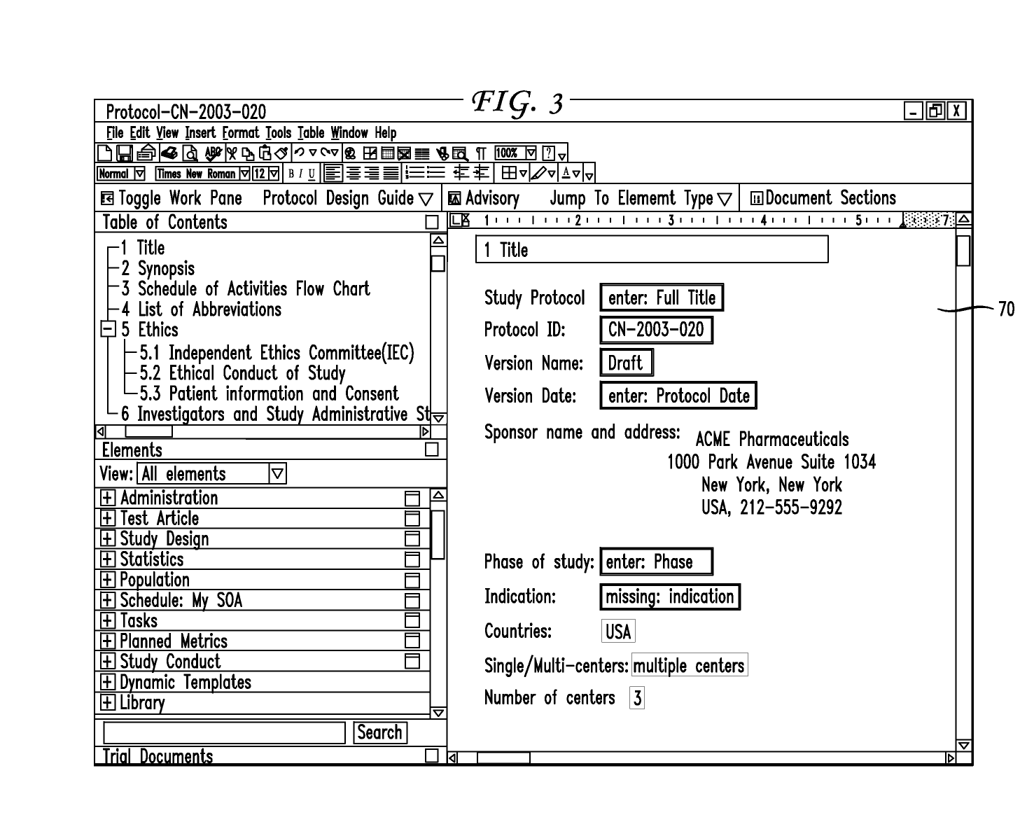

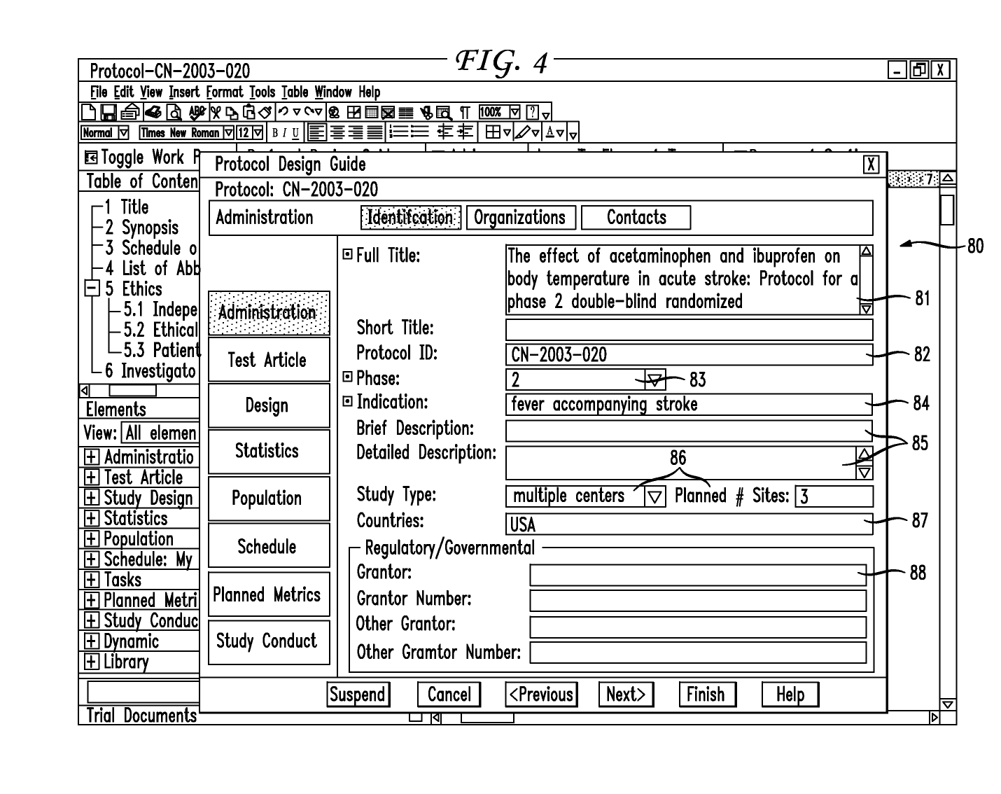

FIGS. 3-13 show computer screen shots 70, 80, 90, 100, 110, 120, 130, 140, 150, 160, and 170 of exemplary displays 12, which may be used in combination with the present invention to plan and design a clinical trial. The present invention permits the protocol to be created using a text-based authoring environment as shown in FIG. 3 at 70, a wizard-based interface as shown in FIGS. 4-13 at 80, 90, 100, 110, 120, 130, 140, 150, 160, and 170 or any other technique known to those skilled in the art that allows important elements of the clinical study to be collected. Important study design information is captured in a database and can be dynamically queried and compared to the overall study complexity in order to understand the design trade-offs and impact of a particular clinical protocol design.

In particular, FIG. 4 provides an example of important study identification information 80 including a full title 81, a protocol ID 82, a phase 83, an indication 84, a description 85, a study type 86, a list of countries 87, and regulatory/governmental information 88.

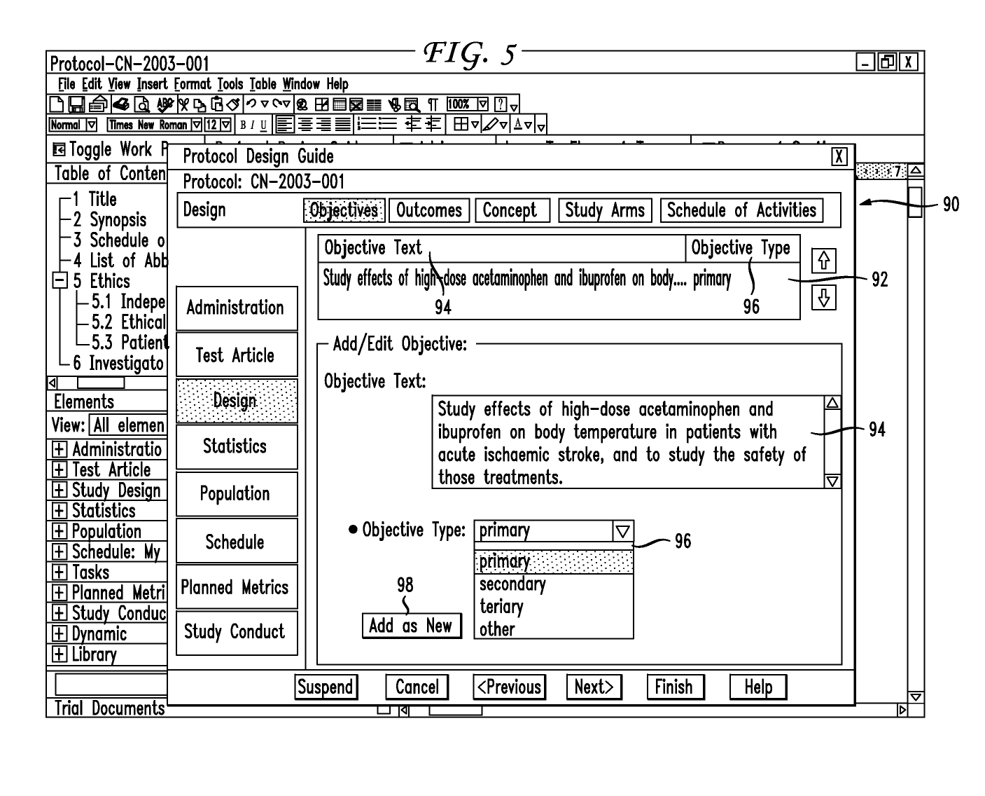

FIG. 5 shows a list of objectives 92 associated with the medical study. The list of objectives includes objective text 94 used to describe the objective and objective type 96, such as the objective listed being a primary purpose, a secondary purpose, a tertiary purpose or some other purpose. The objectives may be selected by typing in a text box, selecting from a list or a pull down menu, and/or any other technique known to those skilled in the art. Moreover, the objectives 94, 96 on the objective list 92 may be edited by including additional objectives 98 or making changes to the listed objectives 94, 96.

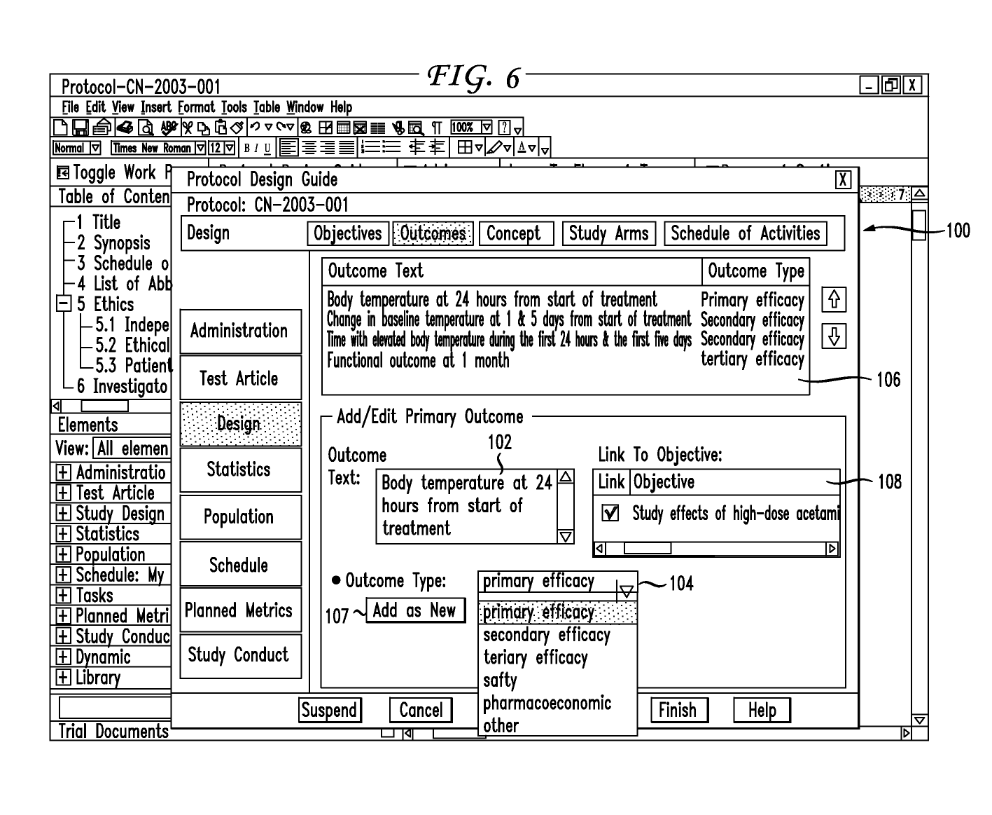

Clinical outcomes may also be measured with outcome text 102 and outcome type 104, such as primary efficacy, secondary efficacy, tertiary efficacy, safety, pharmacoeconomic, and/or any other purpose, as shown in FIG. 6 at 100. The outcomes may be selected by typing in a text box, selecting from a list or a pull down menu, or any other technique known to those skilled in the art. The outcome text 102 and outcome type 104 will then be displayed 106. The outcome 102, 104 may also be edited by including additional objectives 107 or making changes to the included objectives 102, 104. The outcomes screen 100 also allowing a link 108 between the outcomes and previously entered objectives, such as the objectives entered in FIG. 5 at 90.

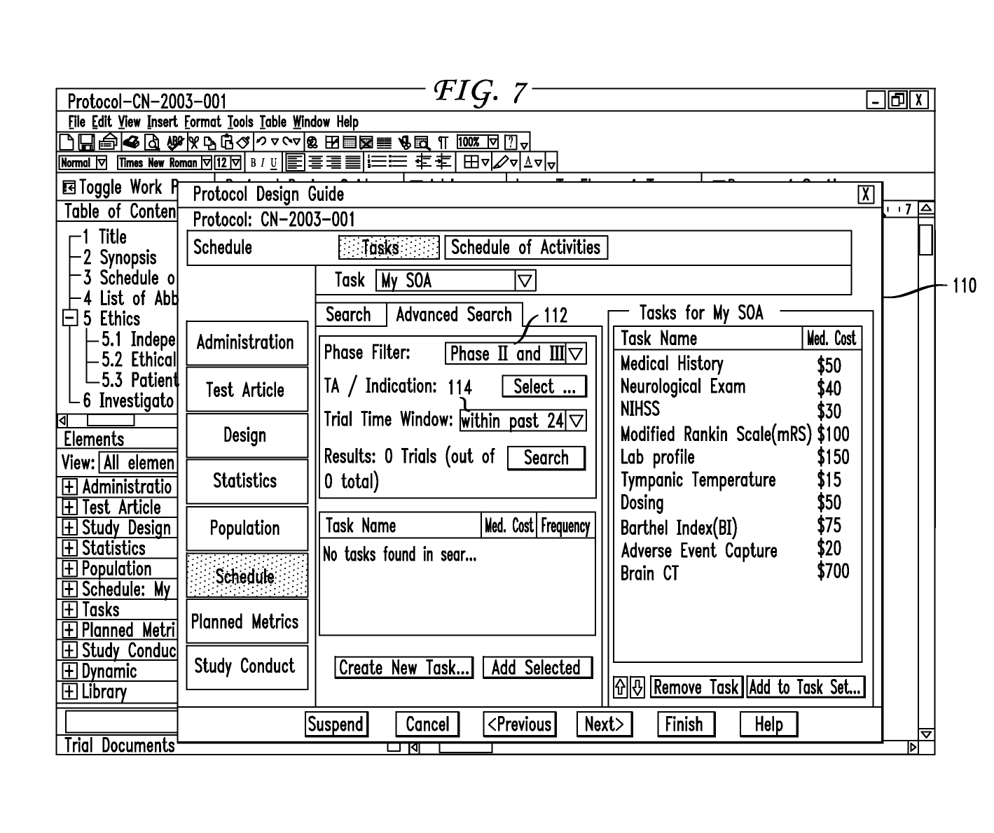

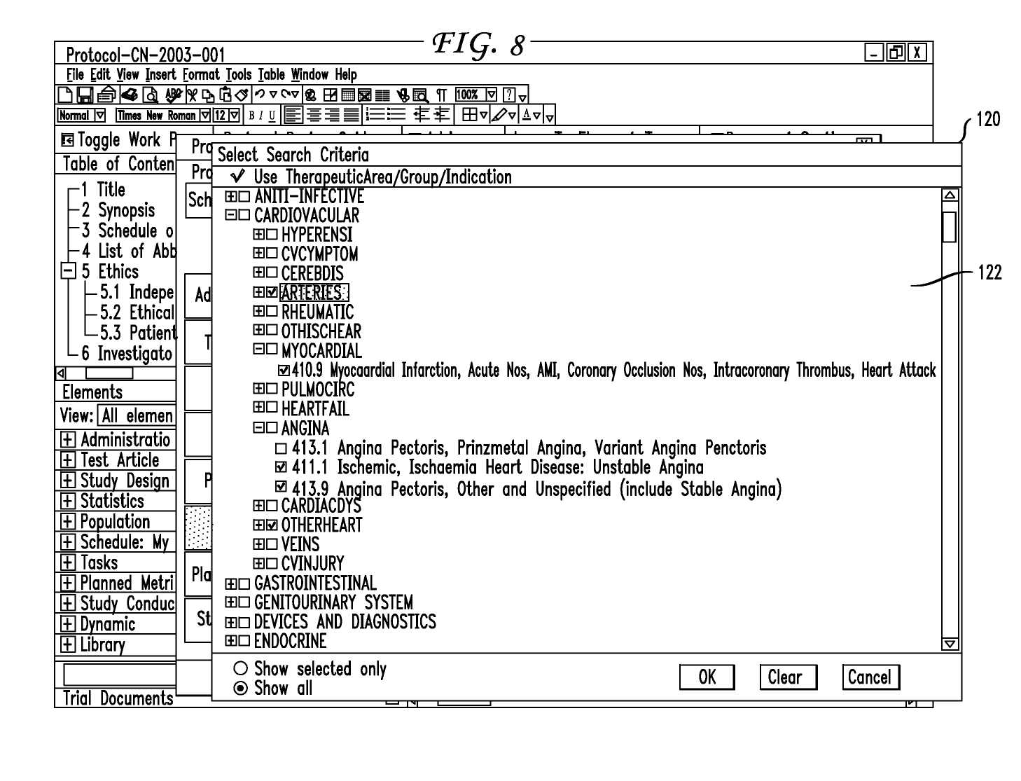

For clinical trial protocols, information of particular importance is the selection of the procedures to be performed, also referred to as tasks. Oftentimes, the complexity of a procedure depends on the type of study (i.e., Phase 1, 2, or 3) and/or the therapeutic area being studied. For example, procedures being performed on a compromised cancer patient in a late stage oncology clinical trial may require more expertise and/or time from the physician than the same procedures performed on a patient enrolled in an allergy trial. Consequently, the invention incorporates a mechanism for selecting a trial phase 112 and trial time 114, as shown in FIG. 7 at 110 and the ability to search for and select a specific therapeutic indication 122, as shown in FIG. 8 at 120.

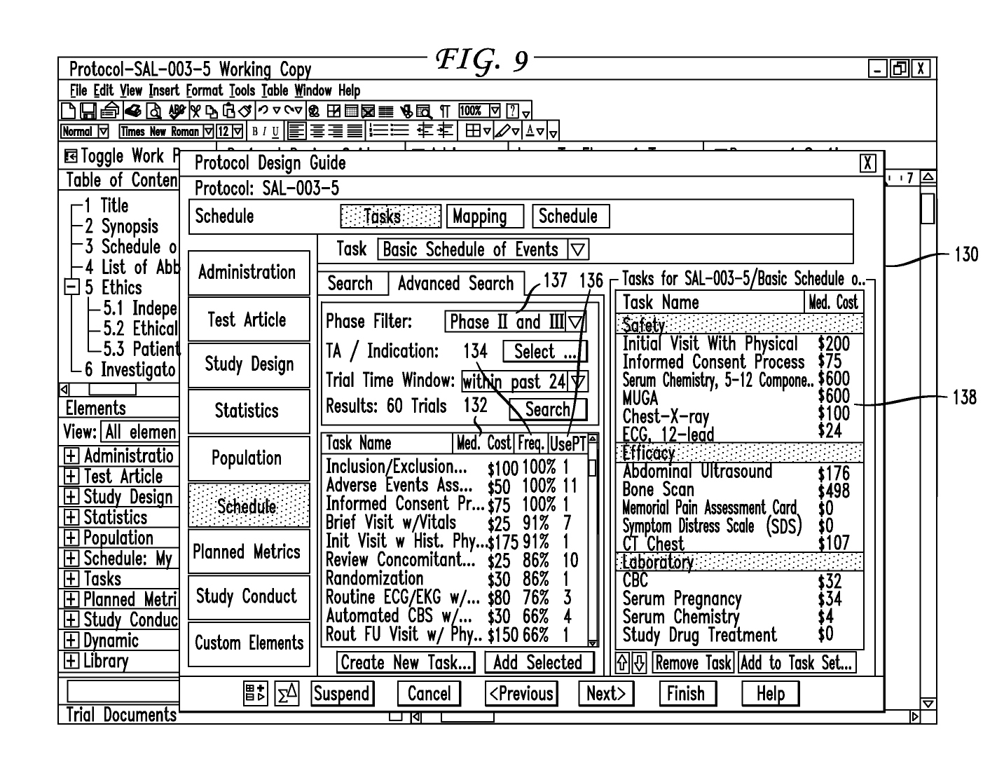

Once the important design study information has been collected, FIG. 9, shows a set of comparator information 130 including a cost 132, a frequency of occurrence 134 represented as a percentage of like trials that include that procedure, and a per trial occurrence rate 136. Optionally, based on the WEU values, the complexity factor for each procedure may be acquired from the database and shown in a panel containing search results 137 and/or included in a selected tasks panel 138.

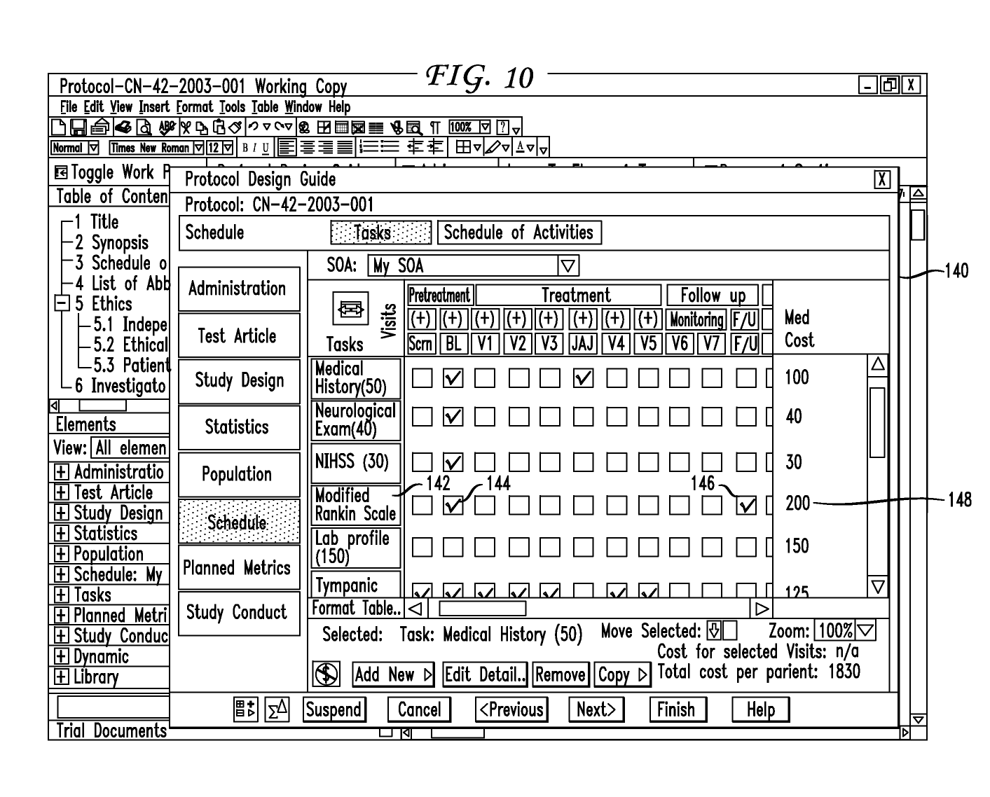

FIG. 10 shows the total cost for each procedure 140, determined by the cost and the total number of times the procedure must be performed. For example, the task labeled Modified Rankin Scale 142 has two boxes checked 144, 146 indicating that the task 142 must be preformed two times. For example, if the cost of each Modified Rankin Scale is $100.00 (see FIG. 7 at 116), the total medical cost, shown by reference 148, would be $200.00, since $100.00 multiplied by two (2) equals $200.00. The present invention further contemplates the ability to include additional columns, such as a column to show a cumulative total of the complexity of the clinical trial.

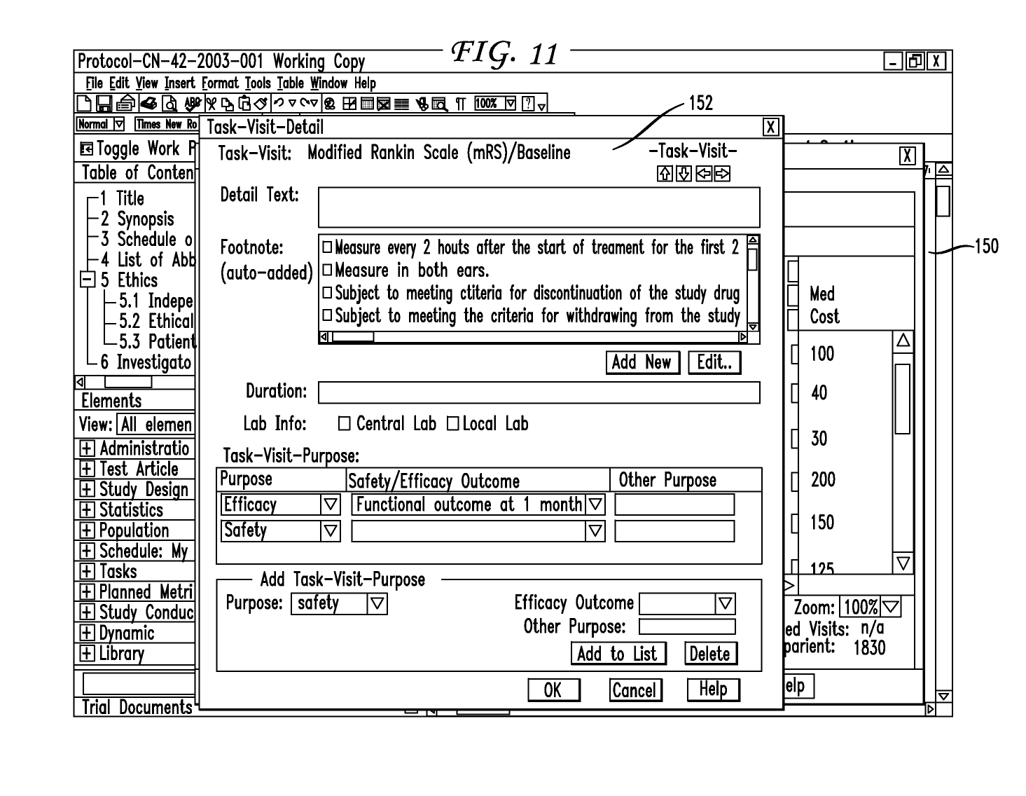

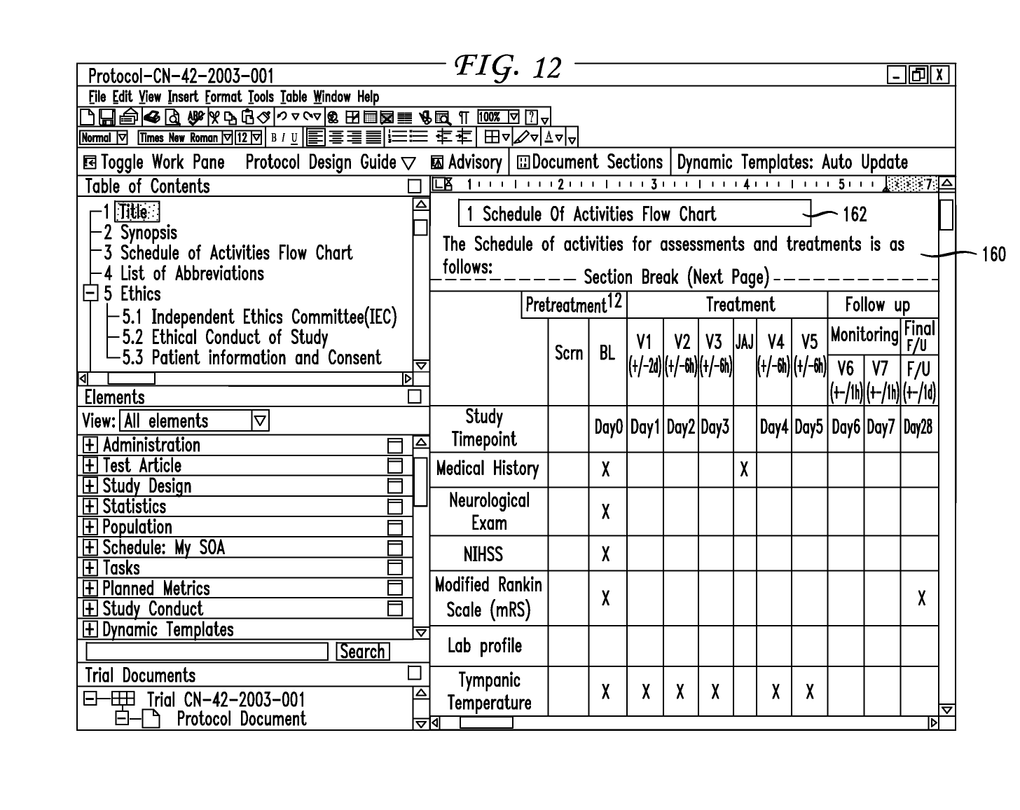

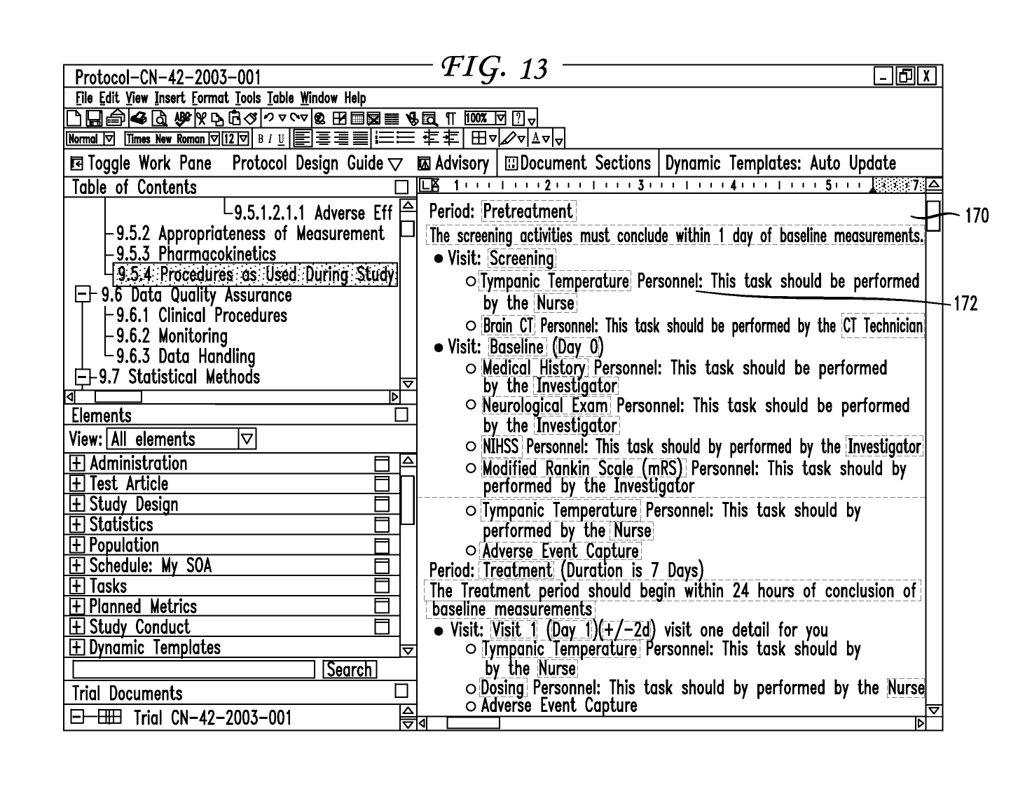

FIGS. 11-13 provide computer screen shots with further details of the clinical trail procedures. FIG. 11 at 150 provides a Task-Visit Detail window 152, for reporting information during the clinical trail. FIG. 12 at 160 shows a schedule of activities for the clinical trail in the form of a flow chart 162. The procedures used during the clinical trial are further outlined in FIG. 13 at 170 with information about the performance of each task 172.

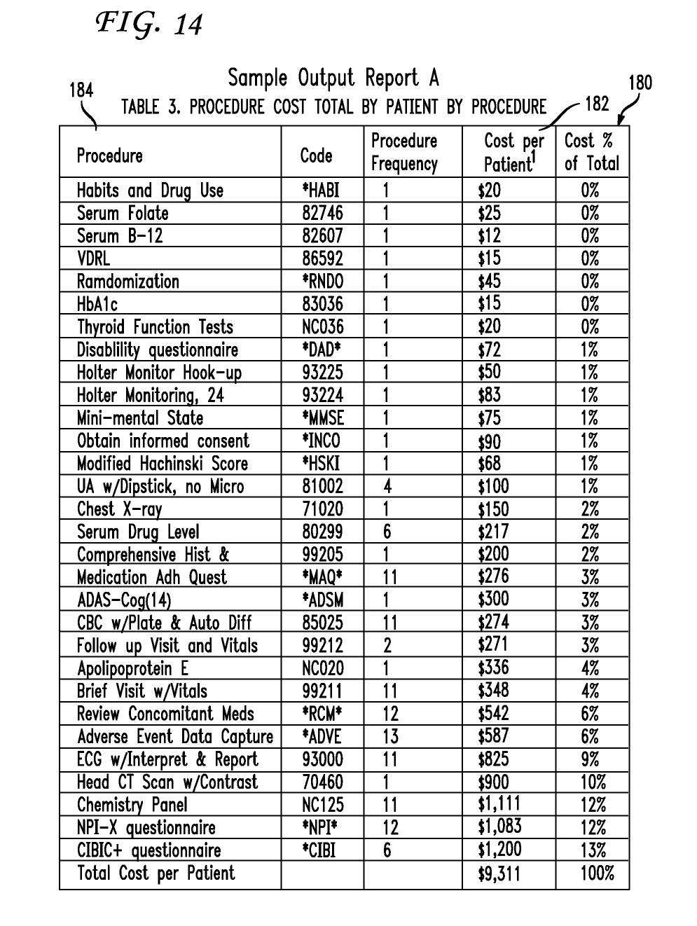

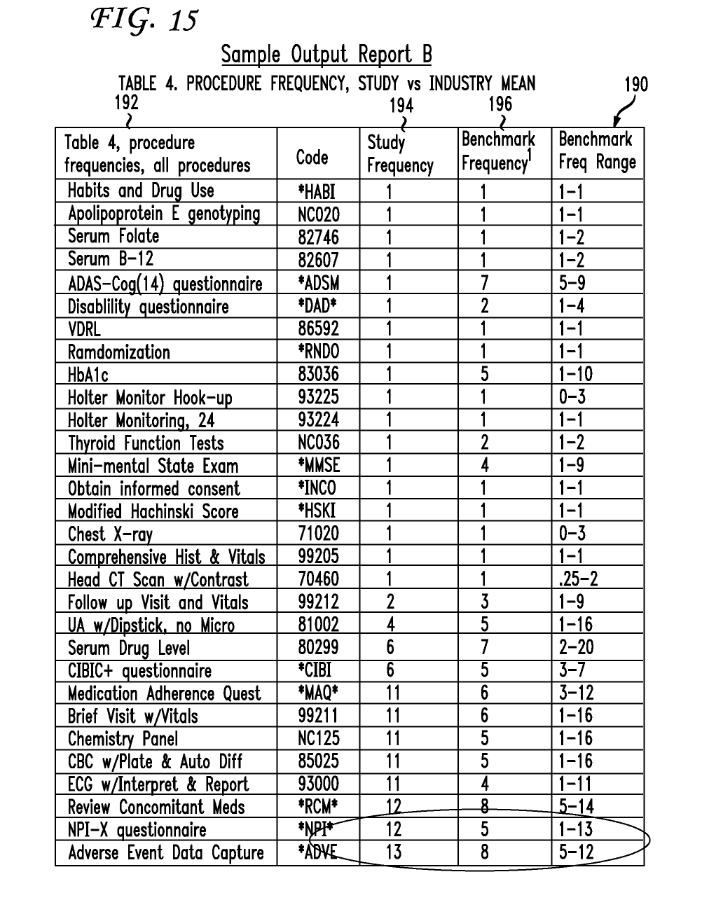

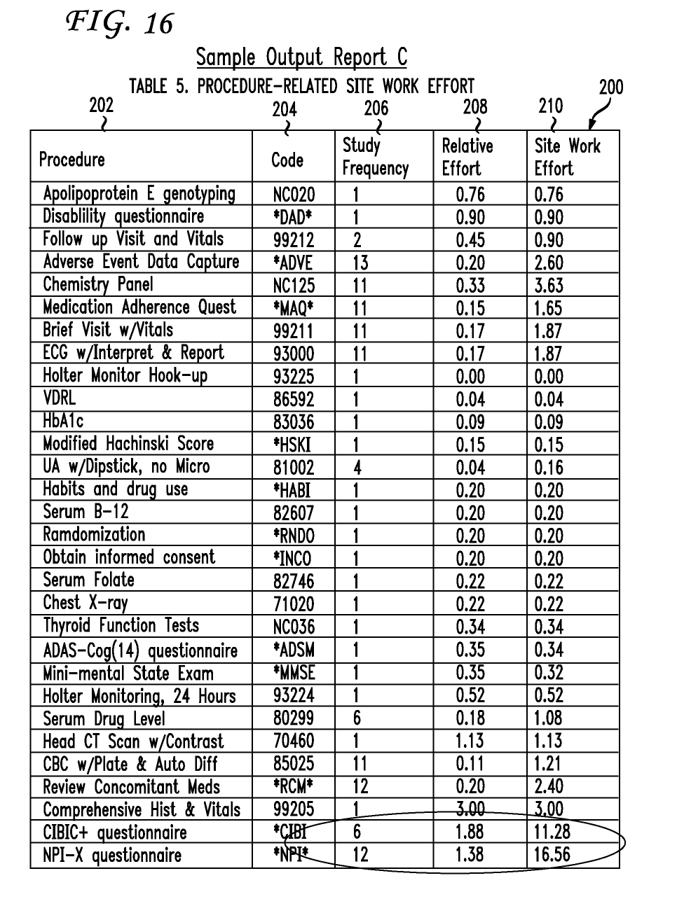

FIGS. 14-16 show sample output reports from the present invention. FIG. 14 at 180 shows procedure cost totals by patient 182 and by procedure 184. FIG. 15 at 190 shows procedure frequency 192 in a particular study 194 verses an industry mean 196. FIG. 16 at 200 provides a report with a procedure name 202, a procedure code 204, a study frequency 206, a relative effort (RVU) 208, and the SWE 210, also referred to as the total work effort of the study.

The information contained in FIGS. 9-16 at 130, 140, 150, 160, 170, 180, 190, and 200 may assist in the assessment of the complexity of the clinical trail. When the clinical trial is being designed, the features described in FIGS. 4-8 at 80, 90, 100, 110, and 120 may then be used to add, delete, or modify the procedures to make the clinical trial more efficient, cost effective, and/or more likely to be acceptable to regulatory bodies and/or reimbursement institutions. For example, suppose a study is designed with a complexity or SWE of 50, where 20 is attributable to the primary objective, 5 to safety, and 25 to the secondary objective. The present invention allows the physician to re-evaluate the number and types of procedures selected for any of the objectives to reduce the overall study; i.e., the physician may re-evaluate the number and types of procedures selected to achieve the secondary objective to reduce the overall study complexity.

Moreover, providing estimates of complexity based on weighted values, such as the cost, the time, the effort, and/or the expertise involved in each procedure, results in improved clinical trials because the valuable assessment tools of the present invention are used in the planning stages of the clinical trial, allowing for multiple assessments and adjustments to procedures based on the evaluation of estimates of the complexity and the objectives of the clinical trial.

It will be appreciated that the present invention has been described herein with reference to certain preferred or exemplary embodiments. The preferred or exemplary embodiments described herein may be modified, changed, added to or deviated from without departing from the intent, spirit and scope of the present invention, and it is intended that all such additions, modifications, amendment and/or deviations be included within the scope of the following claims.

What is claimed is:

1. A system for planning a medical study comprising:
a display device;
a data store comprising a plurality of medical procedures for at least one of designing and executing a medical study;
a service delivery device operatively coupled to said display device and said data store, said service delivery device including a processor and a memory for storing instructions that, in response to receiving a request to plan a medical study, cause the processor to:
select a set of procedures from said plurality of medical procedures;
assign a work effort unit for each procedure included in said set of procedures, said work effort unit based on at least one of procedure type, procedure cost, procedure time, and procedure phase;
calculate a complexity level for said set of procedures based on said work effort units; and
evaluate whether the complexity level is appropriate for said each procedure by comparing said calculated complexity level to a threshold level, said threshold value representing a desirable complexity level for said study.

2. The system of claim 1 wherein the memory stores instructions that, in response to receiving the request, cause the processor to identify unique procedures included in said set of procedures.

3. The system of claim 2 wherein the memory stores instructions that, in response to receiving the request, cause the processor to:
multiply a number of occurrences that each of said unique procedures occurs in said set of procedures by said work effort unit; and
sum said multiplied number of occurrences.

4. The system of claim 3 wherein the memory stores instructions that, in response to receiving the request, cause the processor to sum said multiplied number of occurrences.

5. The system of claim 1 wherein the memory stores instructions that, in response to receiving the request, cause the processor to estimate a cost in administrating at least one of said each procedure included in said set of procedures.

6. The system of claim 1 wherein said processor modifies said set of procedures in response to a comparison of said calculated complexity level to a threshold value.

7. The system of claim 6 wherein the memory stores instructions that, in response to receiving the request, cause the processor to at least one of add, remove and modify at least one of said each procedure included in said set of procedures.

8. A computer-implemented method for employing a computing device to plan and execute a medical study comprising:
selecting a set of medical procedures from a plurality of medical procedures stored in a logical structure within an electronic data store using said computing device;
assigning a work effort unit to each procedure included in said set of medical procedures using a processor of said computing device, said work effort unit based on at least one of procedure type, procedure cost, procedure time, and procedure phase;
calculating a complexity level for said set of medical procedures based on said work effort units using said processor of said computing device; and
evaluating whether the complexity level is appropriate for said each procedure by using said processor of said computing device to compare said calculated complexity level to a threshold level, said threshold value representing a desirable complexity level for said study.

9. The computer-implemented method of claim 8, wherein said step of calculating said complexity level comprises:
multiplying a number of occurrences that each unique procedure occurs in said set of medical procedures by said work effort unit; and
summing said multiplied number of occurrences.

10. The computer-implemented method of claim 8 further comprising the step of modifying said set of procedures in response to a comparison of said calculated complexity level to a threshold value.

11. The computer-implemented method of claim 10, wherein said step of modifying said set of procedures comprises at least one of adding, removing, and modifying at least one of said each procedure included in said set of procedures.

12. The computer-implemented method of claim 8, further comprising the step of using a memory providing instructions to said processor to perform the planning and executing the medical study.

13. The computer-implemented method of claim 8, further comprising the step of said processor receiving a request to plan and execute a medical study prior to performing the steps of selecting, assigning, calculating, and evaluating.

14. A computer-implemented method for employing a computing device to determine a complexity level for a medical study comprising:
determining a work effort unit for each procedure selected from a set of medical procedures stored in a logical structure within an electronic data store, said work effort unit based on at least one of procedure type, procedure cost, procedure time, and procedure phase, wherein a processor in said computing device is employed to assign said work effort unit corresponding to each procedure selected from said set of medical procedures in said electronic data store;
identifying all unique procedures selected from said set of medical procedures in said electronic data store;
multiplying said work effort unit by a number of occurrences of each of said unique procedures selected from said set of medical procedures; and
summing said multiplied work effort units.

15. The computer-implemented method of claim 14, wherein said step of determining said work effort unit is based on an estimated cost in administrating said each procedure selected.

16. The computer-implemented method of claim 15, wherein said estimated cost is determined by a measurement of time to administer said each procedure selected.

17. The computer-implemented method of claim 14, wherein said set of medical procedures are identified by Current Procedural Terminology (CPT) codes.

18. The computer-implemented method of claim 17, wherein the step of determining a work effort unit includes assigning a relative value unit matching said CPT code as the work effort unit.

19. The computer-implemented method of claim 17, wherein the step of determining a work effort unit includes assigning a pre-determined average value to said each procedure selected that
does not contain a matching CPT code and an estimated cost.
